(19) United States
(12) Patent Application Publication
(10) Pub. No.: US 2026/0061971 A1
(43) Pub. Date: Mar. 5, 2026

(54) MOBILE CLEANING AND SANITATION SYSTEM

(71) Applicant: Percy I Whitmore, Phoenix, AZ (US)

(72) Inventor: Percy I Whitmore, Phoenix, AZ (US)

(21) Appl. No.: 19/301,790

(22) Filed: Aug. 15, 2025

Related U.S. Application Data
(60) Provisional application No. 63/732,548, filed on Aug. 28, 2024.

(51) Int. Cl. B60S 3/04; B05B 9/01; B08B 3/02; B08B 5/02; B08B 5/04; B08B 13/00; B60S 3/00; B62B 3/00; B62B 5/00; F21V 21/116

(52) U.S. Cl. CPC B60S 3/044; B05B 9/01; B08B 3/026; B08B 5/02; B08B 5/04; B08B 13/00; B60S 3/008; B62B 3/005; B62B 5/00; B62B 2202/50; F21V 21/116

(57) ABSTRACT

A mobile cleaning and sanitation system that integrates cleaning and sanitation equipment, such as air compressors, wet/dry vacuums, and pressure washers, and associated devices into one integrated system. The system includes a housing telescoping pole extending therefrom and a plurality of wheels attached thereto and is adapted to house a plurality of cleaning and sanitation equipment therein for easy and safe transportation and use.

### CROSS-REFERENCE TO RELATED APPLICATION

The present application is related to and claims priority from prior provisional application Ser. No. 63/732,548, filed Aug. 28, 2024 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to mobile electrical, electromechanical, and chemical cleaning and sanitation distribution systems, and more specifically to a product that integrates cleaning and sanitation equipment, such as air compressors, wet/dry vacuums, and pressure washers, and associated devices into one integrated system.

### 2. Description of the Related Art

Prior art cleaning and sanitation distribution systems collect and load individual pieces of equipment and associated components onto a transportation unit. After ensuring the equipment will not fall off, it can be transported to the desired location. Upon arrival, each piece of equipment must be removed and set up, used as needed, and then relocated back onto the transportation unit. The amount of effort and time necessary during this process is exorbitant and costly. Furthermore, pieces of equipment can be misplaced, lost, and even damaged during this process. Accordingly, the present invention overcomes the disadvantages associated with the prior art.

### BRIEF SUMMARY OF THE INVENTION

In view of the foregoing disadvantages inherent in the known types of cleaning and sanitation distribution systems or the like in the prior art, the present invention provides a mobile cleaning and sanitation system that integrates cleaning and sanitation equipment, such as air compressors, wet/dry vacuums, and pressure washers, and associated devices into one integrated system. The system includes a housing having a telescoping utility pole extending therefrom and a plurality of wheels attached thereto and is adapted to house a plurality of cleaning and sanitation equipment therein for easy and safe transportation and use, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a front view of the mobile cleaning and sanitation system according to the preferred embodiment of the present invention.

FIG. 2 shows a back view of mobile cleaning and sanitation system according to the preferred embodiment of the present invention of FIG. 1.

FIG. 3 shows a side perspective view of the extended nozzles of the mobile cleaning and sanitation system according to the preferred embodiment of the present invention of FIG. 1.

FIG. 4 shows a back view of mobile cleaning and sanitation system including a tool box attached on top of its housing according to the preferred embodiment of the present invention of FIG. 1.

FIG. 5 shows a front view of the mobile cleaning and sanitation system including a camera attached to its utility pole according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

The instant invention is formed as a Mobile Cleaning and Sanitation Station (MCSS) 100, and is a product that integrates utility cleaning equipment and associated devices into one system. This system integrates a pressure washer, wet/dry vacuum, and air compressor functions along with their associated hose management. These integrated systems make work planning, setup, execution, and decommissioning more efficient and effective while reducing equipment handling and coordination.

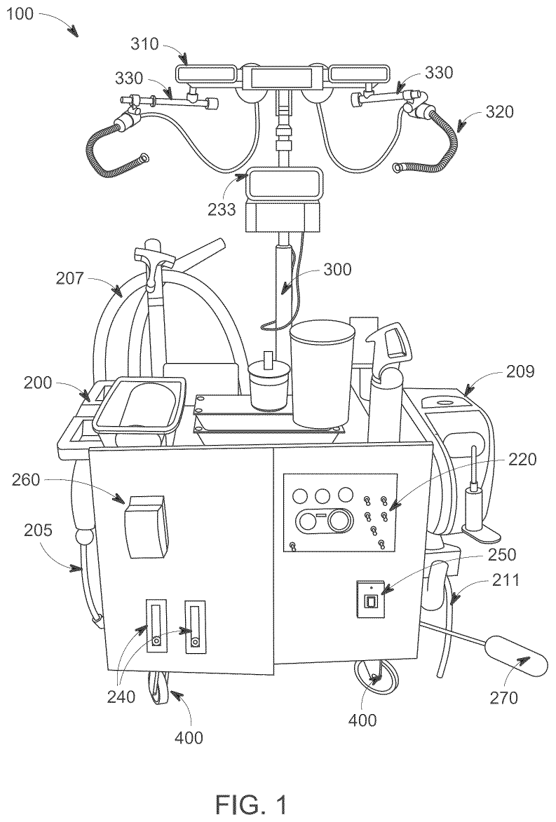

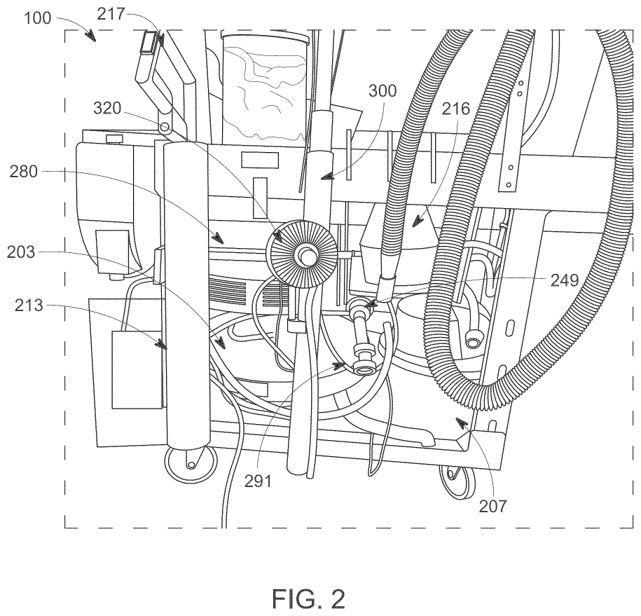

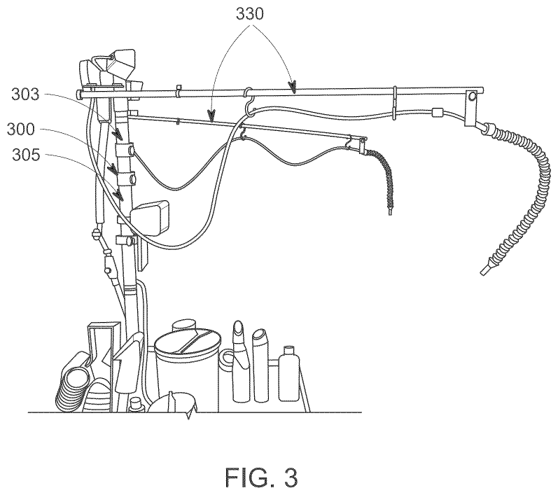

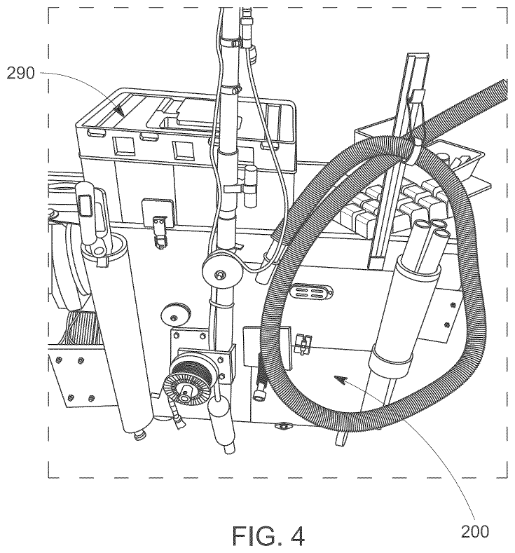

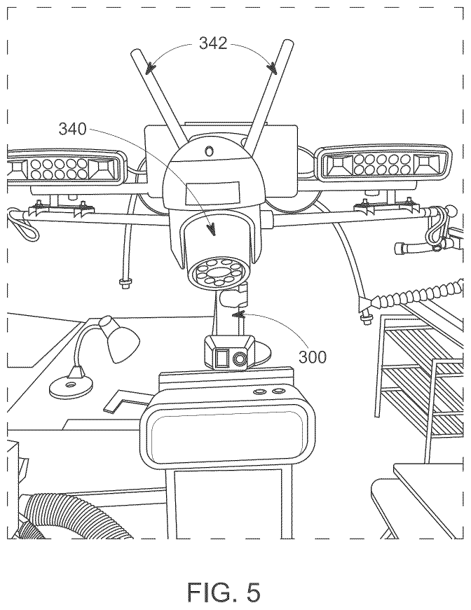

Turning now descriptively to drawing, referring to FIGS. 1-5, the present invention discloses the Mobile Cleaning and Sanitation Station (MCSS) 100 may include two overhead LED area spot lights 310 that provide light for cleaning, area lighting and personnel safety. These lights are operated from the previously mentioned control panel and are dimmable. Hazard/caution lights can also be included on the front and rear and are controlled from telescoping utility pole 300. The unit is powered from a stand-alone 120V AC main power switch 250.

The MCSS 100 may include a stay-wet surface unit 320 which is designed to keep vehicles surfaces wet while cleaning. When cleaning a vehicle in an uncovered area, the sun dries the vehicle's surface leaving soap film or waxy residue. Flexible flow nozzles 330 continuously spread treated water (filtered with a rinse agent added) over the surface being cleaned. These nozzles 330 can be telescoped up to 12 feet vertically and eight feet horizontally from the cleaning surface. The nozzles 330 have shutoff valves attached to the end of telescoping utility pole 300. Water can be directed at any surface while keeping the MCSS 100 stationary. The stay-wet surface unit 320 is operated by a switch on the control panel.

The MCSS 100 consists of two sections, a housing 200, and telescoping utility pole 300 extending from the housing and which can be formed from telescoping members 303 and 305. These two sections support all station components. The housing 200 on-board equipment consists of an air compressor 203 with hose reel 205, wet/dry vacuum 207 with hose and attachments, power washer 209 with unit 216, gun 217, gun holster 213, and hose reel 211, a water hose reel, and a tool box 290. Equipment electrical controls are integrated into a single control panel 220. Chemical injector boards and associated chemical distribution networks are also located inside housing 200.

From the control panel 220, wash and rinse chemicals can be injected into filtered water at a desired rate. The treated water is available at all liquid spray nozzles. Chemical agent levels are seen from backlit liquid level windows 240. Its light switch is also located on the control panel. A 120V AC GFI convenience outlet 260 is also located on the housing 200. The housing 200 topside includes an area where cleaning supplies are stowed. For this application, it is vehicle cleaning supplies. For safety, strobe/caution LED lights can be located on the front and the back. These lights are operated and controlled from the telescoping utility pole 300. This location makes it readily identifiable and accessible. The wet/dry vacuum support rod is where the hose and attachments are mounted. The rod flexes when pulled so that the housing 200 remains stationary.

When in use, water enters the hose connector through the shutoff valve 291 and passes through the water filter 249 where minerals are removed. Filtering improves the cleaning process. The filtered water can then flow in three paths, through the power-washer, water hose, and stay-wet surface unit lines. Wash and rinse chemicals can be injected into the lines where they mix with filtered water and discharged through their perspective nozzles.

A wash and rinse chemical injector board is used for both the water hose and the power washer functions. Solenoid valves control the chemical flow into the wash and rinse water flows respectively. Check valves prevent water back-flow into the non-active flow line. Solenoid valves can be activated by 12V DC switches located on the control panel. When one solenoid valve is activated, for example, cleaning chemicals are available for injection into the water hose and pressure washer lines. Chemicals will only be injected into the line where water is flowing. Another solenoid valve prevents water flow through the pressure washer until it has been powered via a relay located in an electrical box 280. Chemical injection rates can be controlled by metering valves. A pressure washer gun 217 is stowed in a holder that is attached to the housing 200.

The stay-wet surface unit is used to keep vehicle surfaces wet while being cleaned.

When water enters its line, the pressure is reduced to obtain the appropriate flow to the flexible flow nozzles. The injector functions in the same way as the wash and rinse injectors. A solenoid valve allows water to flow to its nozzles. It is controlled by a 12V DC switch located on the control panel.

Chemicals can be stored in containers, one wash and one rinse. These containers supply chemicals to all the injectors. The amount of chemicals injected into the water flow is controlled by metering valves located on the control panel. These valves work by squeezing the tubing to decrease the liquid flow.

The telescoping utility pole 300 attaches to the housing 200 and includes a crossbar that supports the overhead area-spot LED lights and the stay-wet surface unit tubing distribution system. The crossbar can telescope up to 12 feet. Two tabs below the crossbar lock it at a desired height. Below the crossbar is a wireless speaker 233 and a platform, which are both attached to the telescoping utility pole's (300) non-telescoping section 305. Speaker 233 can be used for media entertainment, safety related area announcements, audible warnings, etc. And, a wireless camera 340 that includes antennas 342. As the telescoping utility pole's (300) crossbar is telescoped, the overhead LED lights power connections and stay-wet surface unit tubing connector must also be telescoped. A crossbar pigtail is the utility (power and water) connection point between the telescoping and non-telescoping sections of the telescoping utility pole (300). A power cable is stowed on the non-telescoping section and connects to the power to the pigtail. Tubing for telescoping with its connector is stowed on a spool mounted to the telescoping utility pole. Tubing sections can be connected via a quick disconnect which prevents water flow until the connection has been made. The crossbar pigtail connects a junction box, where both tubing and electrical wires split to provide utilities to each end of the crossbar. Furthermore, the crossbar supports the stay-wet surface unit tubing distribution networks and nozzle support assemblies. To allow the flexible flow nozzles to telescope up to eight feet horizontally, the needing tubing is stored in a round storage unit. These units are attached to the crossbar backside.

The electrical power and control voltages used are 120V AC and 12V DC respectively. Power is supplied from a 120V AC plug 270 which connects to the main power switch. Electrical control devices (relays and associated GFI receptacles) for the 120V AC onboard equipment can be located within the electrical box inside the housing 200. The 120V AC terminal block, also inside the electrical box, is the primary power distribution point. From the 120V AC terminal block, power connects to the 120V AC customer convenience receptacle, wireless speaker receptacle, and 12V DC power supply. The power supply is inside the electrical box.

The 12V DC power supply provides control voltage to control components such as switches, solenoid valve coils, power relay coils, etc. The power supply output is fused to protect users and components in case of an electrical fault. A 12V DC terminal block is the primary control voltage distribution point. Control switches are on the control panel. The electrical components on the telescoping utility pole 300 are fused. The air compressor gage and pressure set-point dial are also located on the control panel. When the compressor power switch is in the on position, the compressor will automatically maintain the tank pressure with respect to the set-point. When the switch is off, the stored pressurized air can be used.

The preferred embodiment includes four locking wheels 400, such that the MCSS 100 can be easily moved and stowed at desired cleaning locations. As a result, chances of workplace injuries are reduced, and operational safety enhanced. For example, when cleaning a fleet vehicle (car, truck, van, etc.) the needed equipment and supplies are on board. To enhance cleaning, in-let water is filtered and chemically treated. A control panel is incorporated so that cleaning chemicals can be injected into filtered water which is available at each liquid flow nozzle. Non-chemically treated water is accessed when both chemical injection switches are in an off position.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A mobile cleaning and sanitation system comprising:
a housing including:
a frame;
wherein said frame is adapted to allow cleaning and sanitation equipment to be releasably attached thereto; and
wherein said frame defines an interior volume adapted to hold cleaning and sanitation equipment therein;
a plurality of wheels;
wherein said plurality of wheels are attached to a bottom portion of said frame and are adapted to allow said mobile cleaning and sanitation system to be mobile;
a utility pole;
wherein said utility pole is attached to and extends from said housing and is adapted to releasably hold members of said cleaning and sanitation equipment thereon and spaced from said housing;
an air compressor including:
a hose;
wherein said air compressor is releasably attached to said frame;
a wet/dry vacuum including:
a hose;
wherein said wet/dry vacuum is releasably attached to said frame;
a power washer including:
a hose; and
a power washer gun;
wherein said power washer is releasably attached to said frame; and
a control panel;
wherein said control panel is releasably attached to said frame; and
wherein said control panel is electrically connected to said air compressor,
said wet/dry vacuum, and said power washer to thereby control their respective functions;
wherein said mobile cleaning and sanitation system is adapted to be mobile and capable of cleaning and sanitizing chosen objects.

2. The mobile cleaning and sanitation system of claim 1, wherein said utility pole is formed from a plurality of telescoping sections adapted to adjustably extend the length thereof.

3. The mobile cleaning and sanitation system of claim 1, wherein said frame is formed in the shape of a rectangular volume; and said plurality of wheels are formed as four wheels at respective bottom corners of said rectangular volume.

4. The mobile cleaning and sanitation system of claim 1, wherein said utility pole includes a
plurality of LED area spot lights attached thereto.

5. The mobile cleaning and sanitation system of claim 1, wherein said utility pole includes a plurality of extendable nozzles attached thereto.

6. The mobile cleaning and sanitation system of claim 1, wherein said utility pole includes a speaker attached thereto.

7. The mobile cleaning and sanitation system of claim 1, wherein said chosen objects are chosen from a list consisting of cars, trucks, and vans.

8. The mobile cleaning and sanitation system of claim 1, further comprising a tool box releasably attached to said frame.

9. The mobile cleaning and sanitation system of claim 1, wherein said utility pole includes a
wireless camera attached thereto; wherein said camera includes at least one antenna adapted to send images remotely. [0004]
